(19) United States
(12) Patent Application Publication
(10) Pub. No.: US 2019/0133400 A1
(43) Pub. Date: May 9, 2019

(54) ADJUSTING HEIGHT OF A ROBOTIC CLEANING DEVICE

(71) Applicant: Aktiebolaget Electrolux, Stockholm (SE)

(72) Inventors: Andreas Klintemyr, Stockholm (SE); Niklas Nordin, Stockholm (SE)

(21) Appl. No.: 16/099,780

(22) PCT Filed: May 11, 2016
(86) PCT No.: PCT/EP2016/060565

§ 371 Date: Nov. 8, 2018

(51) Int. Cl. A47L 11/40; G05D 1/02; B25J 11/00; B25J 13/00

(52) U.S. Cl. CPC A47L 11/4058; G05D 1/027; G05D 1/0238; A47L 2201/04; B25J 11/0085; B25J 13/006; A47L 11/4061

(57) ABSTRACT

A method of adjusting a height of a robotic cleaning device over a surface across which the robotic cleaning device moves, and a robotic cleaning device performing the method. The method includes receiving a signal indicative of a need to adjust height of the robotic cleaning device over the surface, and controlling, in response to the received signal, at least one actuator configured to adjust height of the robotic cleaning device in accordance with the indicated need.

### TECHNICAL FIELD

The invention relates to a method of adjusting height of a robotic cleaning device over a surface across which the robotic cleaning device moves, and a robotic cleaning device performing the method.

### BACKGROUND

In many fields of technology, it is desirable to use robots with an autonomous behaviour such that they freely can move around a space to undertake a designated task, such as for instance cleaning, without colliding with possible obstacles.

Robotic vacuum cleaners are know in the art, which are equipped with drive means in the form of a motor for moving the cleaner across a surface to be cleaned. The robotic vacuum cleaners are further equipped with intelligence in the form of microprocessor(s) and navigation means for causing an autonomous behaviour such that the robotic vacuum cleaners freely can move around and clean a surface in the form of e.g. a room. Thus, these prior art robotic vacuum cleaners have the capability of more or less autonomously vacuum clean a room in which objects such as tables and chairs and other obstacles such as walls and stairs are located.

Robotic cleaners that move around in home environments have to handle unevenness of floors, e.g. caused by both thicker end thinner carpets, as well as climbing thresholds, passing cables and moving over soft surfaces such as carpets, both thin carpets and thicker rugs. In order to provide efficient cleaning capability, as well as being able to pass under obstacles, a close distance to the floor surface is needed. This requires a variable drive wheel position in a vertical direction in order to ensure sufficient traction between the drive wheels and the surface in all different wheel positions.

This is commonly solved by means of a respective spring arranged between a main body of the robotic cleaning and each driving wheel to adjust a force with which the drive wheels are pressed against the floor. However, this solution does not provide for a flexible adjustment of the vertical drive wheel position of the robotic cleaner.

### SUMMARY

Thus, an object of the invention is to solve, or at least mitigate this problem and provide an improved method of adjusting height of a robotic cleaning device over a surface to be cleaned.

This object is attained in a first aspect of the invention by a method of adjusting height of a robotic cleaning device over a surface across which the robotic cleaning device moves. The method comprises receiving a signal indicative of a need to adjust height of the robotic cleaning device over the surface, and controlling, in response to the received signal, at least one actuator configured to adjust height of the robotic cleaning device in accordance with the indicated need.

This object is attained in a second aspect of the invention by a robotic cleaning device comprising at least one actuator configured to adjust height of the robotic cleaning device over a surface across which the robotic cleaning device moves, and a controller configured to receive a signal indicative of a need to adjust height of the robotic cleaning device over the surface and further to control, in response to the received signal, the at least one actuator configured to adjust height of the robotic cleaning device in accordance with the indicated need.

By providing a robotic cleaning device, the height of which may be adjusted over the surface across which it moves, a number of advantages is achieved; firstly, it may be performed to avoid colliding with objects, and secondly it may be performed to facilitate movement over objects/surfaces not easily traversed, such as thick rugs. Further, it may be advantageously performed to optimize cleaning capacity of the robotic cleaning device, where the height could be adjusted to be higher in case of a smooth easy-cleaned surface such as a parquet of linoleum floor, while it would be adjusted to be lower in case of a structured surface such as a fitted carpet where the debris is not as easily removed.

In an embodiment, upon receiving a signal indicative of a need to adjust the height of the robotic cleaning device, the controller controls the actuator(s), being for instance a piston device, to adjust a position of drive wheel(s) of the robotic cleaning device with respect to a main body of the robotic cleaning device to attain the height adjustment.

In an embodiment, the robotic cleaning device further comprises an object detection device, such as a 3D camera, a laser scanner or a bumper, configured to detect an object encountered by the robotic cleaning device. In response thereto, the controller receives a signal from the object detection device in response to detecting the object, which indicates the need to adjust the height of the robotic cleaning device over the surface. For instance, upon encountering a threshold, the object detection device detects the threshold and signals the controller of the detected object, which accordingly controls the actuators to increase the height of the robotic cleaning device to advantageously avoid colliding with the threshold.

In a further embodiment, the robotic cleaning device further comprises a surface detection device advantageously configured to detect type of surface across which the robotic cleaning device moves and signal the controller accordingly.

For instance, if the robotic cleaning device moves over a floor such as a parquet floor, it can move very close to the floor, while if traversing a thick rug, it may be necessary to travel over the rug with the robot body in a more elevated position.

A number of embodiments are envisaged for implementing the surface detection device.

In one embodiment, the robotic cleaning device is equipped with a surface detection device in the form of an inertia measurement unit (IMU), such as e.g. a gyroscope, accelerometer, magnetometer, etc. By measuring the orientation of the robotic cleaning device with the IMU, it can advantageously be concluded by the controller over which type of surface the robotic cleaning device moves, and any required change in height may be performed by controlling the actuators.

In another embodiment, the robotic cleaning device uses a suction fan configured to create an air flow for transporting debris from the surface across which the robotic cleaning device moves to a container in the main body via an opening in the bottom side of the main body of the robotic cleaning device, and a fan motor (121) configured to drive the suction fan, as a surface detection device. Advantageously, by monitoring the operational current of the fan motor, it can be concluded by the controller over which type of surface the robotic cleaning device moves, and any required change in height may be performed by controlling the actuators.

In yet another embodiment, the robotic cleaning device uses a brush roll configured to remove debris from the surface across which the robotic cleaning device moves, and a brush roll motor configured to rotate the brush roll, as a surface detection device. Advantageously, by monitoring the operational current of the brush roll motor, it can be concluded by the controller over which type of surface the robotic cleaning device moves, and any required change in height may be performed by controlling the actuators.

In still another embodiment, the robotic cleaning device uses one or more driving wheels configured to cause the robotic cleaning device to move across the surface, and one or more wheel motors configured to rotate the driving wheel(s), as a surface detection device. Advantageously, by monitoring the operational current of the wheel motors, it can be concluded by the controller over which type of surface the robotic cleaning device moves, and any required change in height may be performed by controlling the actuators.

It is noted that a camera, such as a 3D camera, may be used both as an object detection device and a surface detection device.

In a further embodiment, the robotic cleaning device is equipped with a user interface communicatively coupled to the controller, via which a user manually can instruct the robotic cleaning device to adjust its height.

In yet a further embodiment, the user need not provide input to the user interface by physically operating the interface, but may alternatively communicate wirelessly with the user interface via a remote control. It may further be envisaged that a central robot control system sends wireless operating signals to the user interface of the robotic cleaning device via for instance Wireless Local Area Network (WLAN).

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 shows a robotic cleaning device according to an embodiment of the present invention in a bottom view;

FIG. 2a illustrates a side view of a robotic cleaning device in an embodiment moving to over a floor to be cleaned and approaching a threshold;

FIG. 2b illustrates a flowchart illustrating the method according to the embodiment of FIG. 2a;

FIG. 3 shows a robotic cleaning device according to an embodiment of the present invention in a front view;

FIG. 4 shows the robotic cleaning device according to the embodiment of FIG. 3 performing a tilting movement;

FIG. 5a illustrates a side view of a robotic cleaning device in an embodiment moving over a floor to be cleaned and approaching a rug;

FIG. 5b illustrates a flowchart illustrating the method according to the embodiment of FIG. 5a;

FIG. 6a illustrates a side view of a robotic cleaning device in another embodiment moving over a floor to be cleaned and approaching a rug;

FIG. 6b illustrates a flowchart illustrating the method according to the embodiment of FIG. 6a; and

FIG. 7 illustrates adjustment of height according to embodiments via a user interface.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

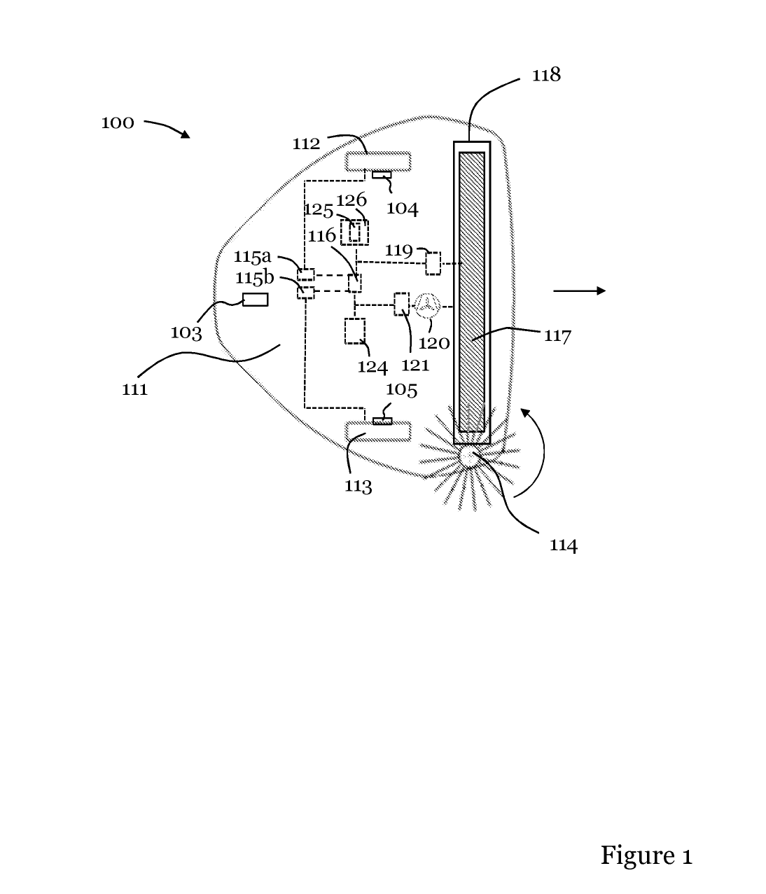

Even though it is envisaged that the invention may be performed by any appropriate robotic cleaning device being equipped with sufficient processing intelligence, FIG. 1 shows a robotic cleaning device 100 according to an embodiment of the present invention in a bottom view, i.e. the bottom side of the robotic cleaning device is shown. The arrow indicates the forward direction of the robotic cleaning device 100 being illustrated in the form of a robotic vacuum cleaner, but e.g. robotic sweepers or robotic floor washers may be envisaged. The robotic cleaning device according to the invention can be mains-operated and have a cord, be battery-operated or use any other kind of suitable energy source, for example solar energy.

The robotic cleaning device 100 comprises a main body 111 housing components such as a propulsion system comprising driving means in the form of two electric wheel motors 115a, 115b for enabling movement of the driving wheels 112, 113 such that the cleaning device can be moved over a surface to be cleaned. Each wheel motor 115a, 115b is capable of controlling the respective driving wheel 112, 113 to rotate independently of each other in order to move the robotic cleaning device to across the surface to be cleaned. A number of different driving wheel arrangements, as well as various wheel motor arrangements, can be envisaged. It should be noted that the robotic cleaning device may have any appropriate shape, such as a device having a more traditional circular-shaped main body, or a triangular-shaped main body. As an alternative, a track propulsion system may be used or even a hovercraft propulsion system. The propulsion system may further be arranged to cause the robotic cleaning device 100 to perform any one or more of a yaw, pitch, translation or roll movement.

Actuators 104, 105 are further arranged at the first driving wheel 112 and the second driving wheel 113, respectively, to accomplish a desired height of the bottom side of the main body 111 over a surface to be cleaned. The actuators may be embodied in the form of pistons employing e.g. electromechanical, pneumatic, hydraulic or electrical operation. The robotic vacuum cleaner 100 may further be equipped with a supporting wheel 103.

A controller 116 such as a microprocessor controls the wheel motors 115a, 115b to rotate the driving wheels 112, 113 as required in view of information received from an object detecting device (not shown in FIG. 1) for detecting obstacles in the form of walls, floor lamps, table legs, around which the robotic cleaning device must navigate. The object detecting device may be embodied in the form of a 3D sensor system registering its surroundings, implemented by means of e.g. a 3D camera, a camera in combination with lasers, a laser scanner, etc., or even a bumper, for detecting obstacles and communicating information about any detected obstacle to the microprocessor 116. The microprocessor 116 communicates with the wheel motors 115a, 115b to control movement of the wheels 112, 113 in accordance with information provided by the object detecting device such that the robotic cleaning device 100 can move as desired across the surface to be cleaned.

Further, the main body 111 may optionally be arranged with a cleaning member 117 for removing debris and dust from the surface to be cleaned in the form of a rotatable brush roll arranged in an opening 118 at the bottom of the robotic cleaner 100. Thus, the rotatable brush roll 117 is arranged along a horizontal axis in the opening 118 to enhance the dust and debris collecting properties of the cleaning device 100. In order to rotate the brush roll 117, a brush roll motor 119 is operatively coupled to the brush roll to control its rotation in line with instructions received from the controller 116.

Moreover, the main body 111 of the robotic cleaner 100 may comprises a suction fan 120 creating an air flow for transporting debris to a dust bag or cyclone arrangement (not shown) housed in the main body via the opening 118 in the bottom side of the main body 111. The suction fan 120 is driven by a fan motor 121 communicatively connected to the controller 116 from which the fan motor 121 receives instructions for controlling the suction fan 120. It should be noted that a robotic cleaning device having either one of the rotatable brush roll 117 and the suction fan 120 for transporting debris to the dust bag can be envisaged. A combination of the two will however enhance the debris-removing capabilities of the robotic cleaning device 100.

The robotic cleaning device 100 may further be equipped with an inertia measurement unit (IMU) 124, such as e.g. a gyroscope and/or an accelerometer and/or a magnetometer or any other appropriate device for measuring displacement of the robotic cleaning device 100 with respect to a reference position, in the form of e.g. orientation, rotational velocity, gravitational forces, etc. A three-axis gyroscope is capable of measuring rotational velocity in a roll, pitch and yaw movement of the robotic cleaning device 100. A three-axis accelerometer is capable of measuring acceleration in all directions, which is mainly used to determine whether the robotic cleaning device is bumped or lifted or if it is stuck (i.e. not moving even though the wheels are turning). The robotic cleaning device 100 further comprises encoders (not shown in FIG. 1) on each drive wheel 112, 113 which generate pulses when the wheels turn. The encoders may for instance be magnetic or optical. By counting the pulses at the controller 116, the speed of each wheel 112, 113 can be determined. By combining wheel speed readings with gyroscope information, the controller 116 can perform so called dead reckoning to determine position and heading of the cleaning device 100.

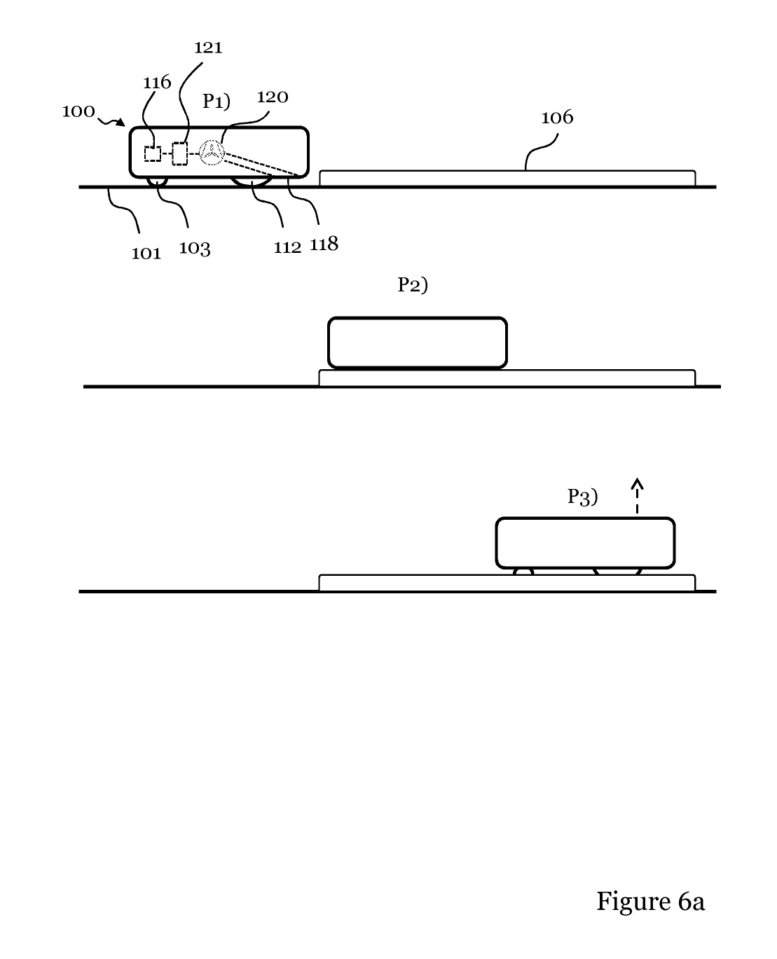

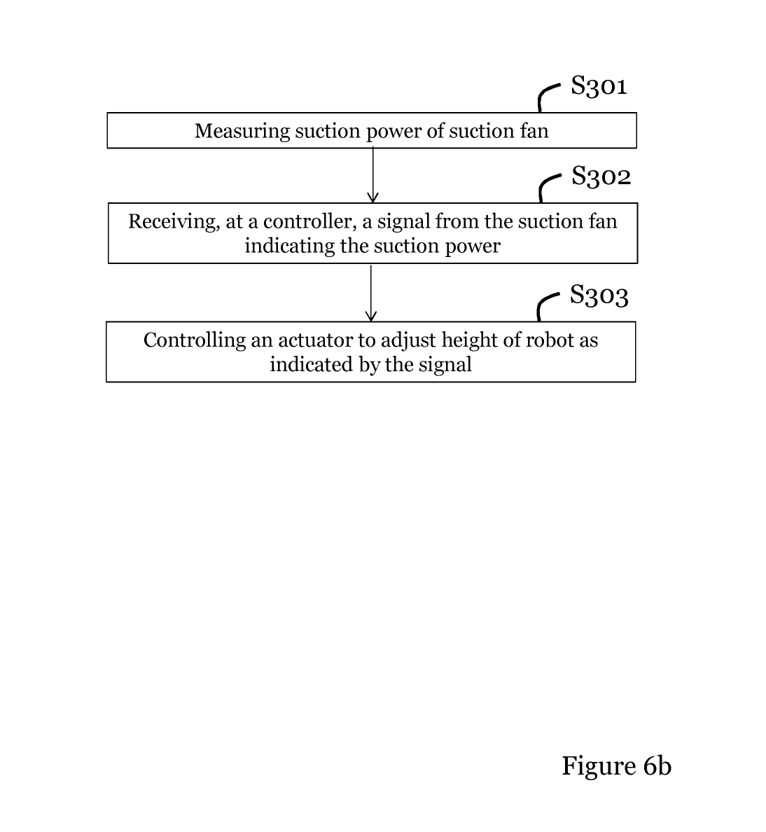

The main body 111 may further be arranged with a rotating side brush 114 adjacent to the opening 118, the rotation of which could be controlled by the drive motors 115a, 115b, the brush roll motor 119, or alternatively a separate side brush motor (not shown). Advantageously, the rotating side brush 114 sweeps debris and dust such from the surface to be cleaned such that the debris ends up under the main body 111 at the opening 118 and thus can be transported to a dust chamber of the robotic cleaning device. Further advantageous is that the reach of the robotic cleaning device 100 will be improved, and e.g. corners and areas where a floor meets a wall are much more effectively cleaned. As is illustrated in FIG. 6, the rotating side brush 114 rotates in a direction such that it sweeps debris towards the opening 118 such that the suction fan 120 can transport the debris to a dust chamber. The robotic cleaning device 100 may comprise two rotating side brushes arranged laterally on each side of, and adjacent to, the opening 118.

With further reference to FIG. 1, the controller/processing unit 116 embodied in the form of one or more microprocessors is arranged to execute a computer program 125 downloaded to a suitable storage medium 126 associated with the microprocessor, such as a Random Access Memory (RAM), a Flash memory or a hard disk drive. The controller 116 is arranged to carry out a method according to embodiments of the present invention when the appropriate computer program 125 comprising computer-executable instructions is downloaded to the storage medium 126 and executed by the controller 116. The storage medium 126 may also be a computer program product comprising the computer program 125. Alternatively, the computer program 125 may be transferred to the storage medium 126 by means of a suitable computer program product, such as a digital versatile disc (DVD), compact disc (CD) or a memory stick. As a further alternative, the computer program 125 may be downloaded to the storage medium 126 over a wired or wireless network. The controller 116 may alternatively be embodied in the form of a digital signal processor (DSP), an application specific integrated circuit (ASIC), a field-programmable gate array (FPGA), a complex programmable logic device (CPLD), etc.

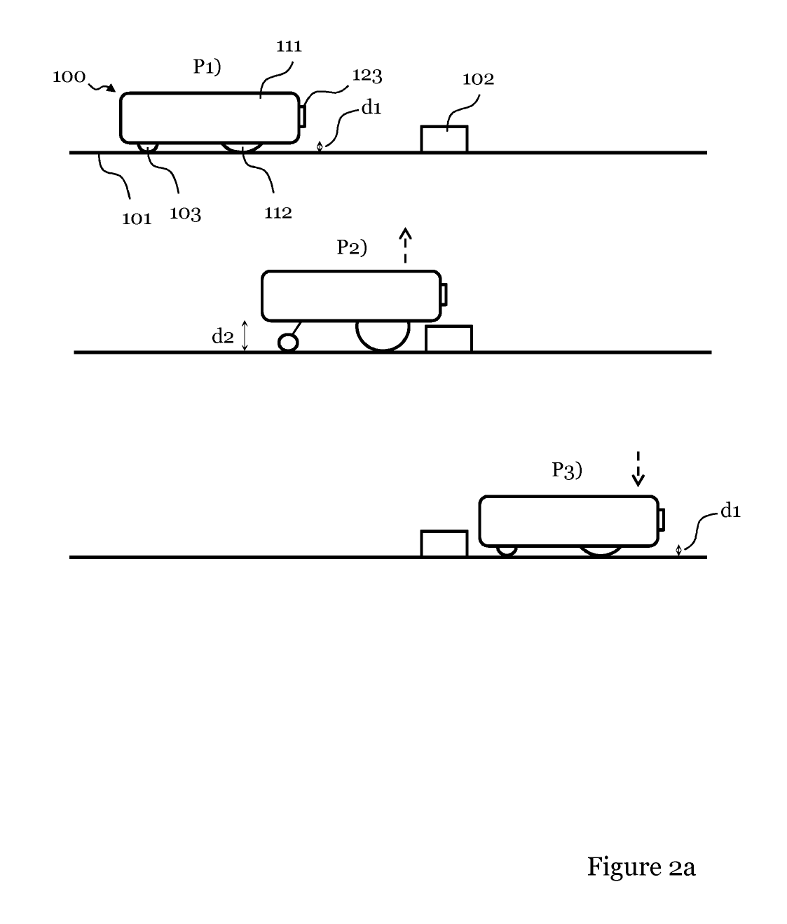

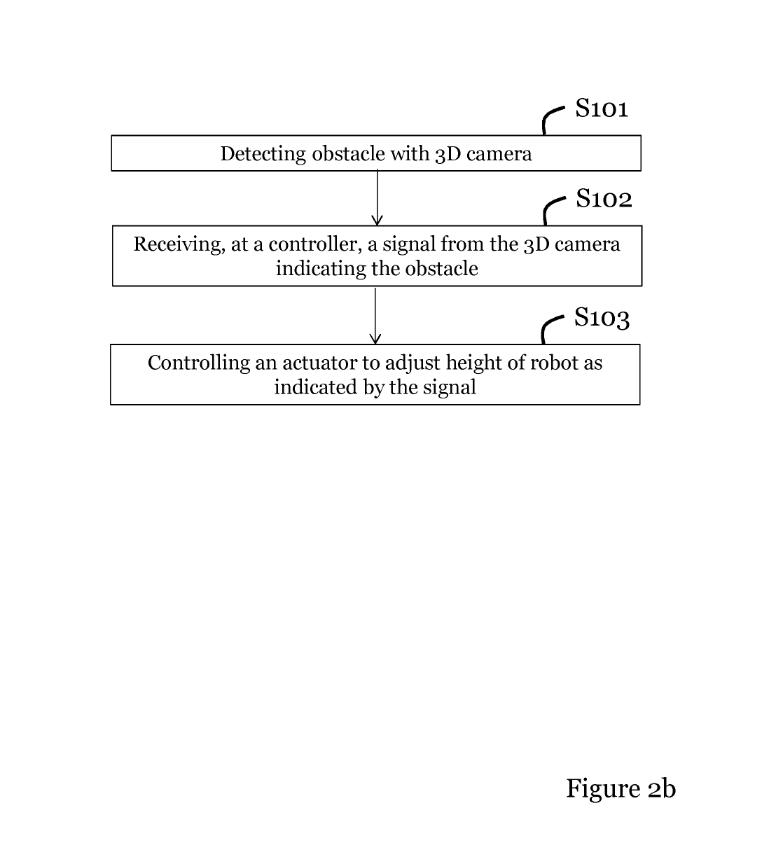

FIG. 2a illustrates a side view of a robotic cleaning device 100 in the form of a robotic vacuum cleaner moving over a floor 101 to be cleaned and approaching a threshold 102. In this particular embodiment, it is assumed that the robotic cleaning device is equipped with an object detecting system 123, such as e.g. a 3D camera, with which it is capable of detecting any object is encounters well in advance of approaching the object. Reference is further made to a flowchart of FIG. 2b illustrating a method according to this embodiment.

As further is shown, the robotic vacuum cleaner 100 comprises a propulsion system which comprises driving means in the form of at least one electric wheel motor (not shown in FIG. 2a) for enabling driving of at least one driving wheel 112 to cause the robotic vacuum cleaner 100 to move over the surface 101 to be cleaned. The robotic vacuum cleaner 100 may further by equipped with a supporting wheel 103, which may or may not be driven by the electric wheel motor.

In a first position P1, the robotic vacuum cleaner 100 moves over a floor 101 such as a parquet floor, meaning that the robot can move very close to the floor 101, illustrated by distance d1 from a main body 111 of the vacuum cleaner 100 to the floor 101, which practically could be about 1 cm or less.

At position P1, the 3D camera 123 thus detects in step S101 an obstacle in the form of the threshold 102 to be encountered by the robotic cleaning device 100 and signals to a controller (not shown in FIG. 1a) that the obstacle 102 has been detected in step S102. The controller accordingly receives a signal indicative of a need to adjust height of the robotic cleaning device 100 over the surface 101 to be cleaned.

In response to the signal received from the object detection device, the controller controls in step S103 an actuator (not shown in FIG. 1a) configured to adjust height of the robotic cleaning device 100 in accordance with the indicated need. Hence, at position P2, the height of the robotic vacuum cleaner 100 over the floor 100 has been adjusted to d2, which in practice may be a distance of 3-5 cm, by the actuator pressing the drive wheel 112 (and possibly the support wheel 103) towards the floor 101, thereby causing the main body 111 to be elevated to distance d2.

As a result, the robotic vacuum cleaner 100 may advantageously traverse the threshold 102 without colliding with and/or getting stuck on the threshold 102.

After having traversed the threshold 102 at position P3, the 3D camera will capture images only showing the floor (and no obstacles). The controller hence concludes that the height again shall be adjusted, and signals accordingly to the actuator, which decreases the height of the robot 100 over the floor 101, again to distance d1. This is done by the actuator releasing the pressure on the drive wheel 112 thereby causing the main body 111 to be lowered to distance d1.

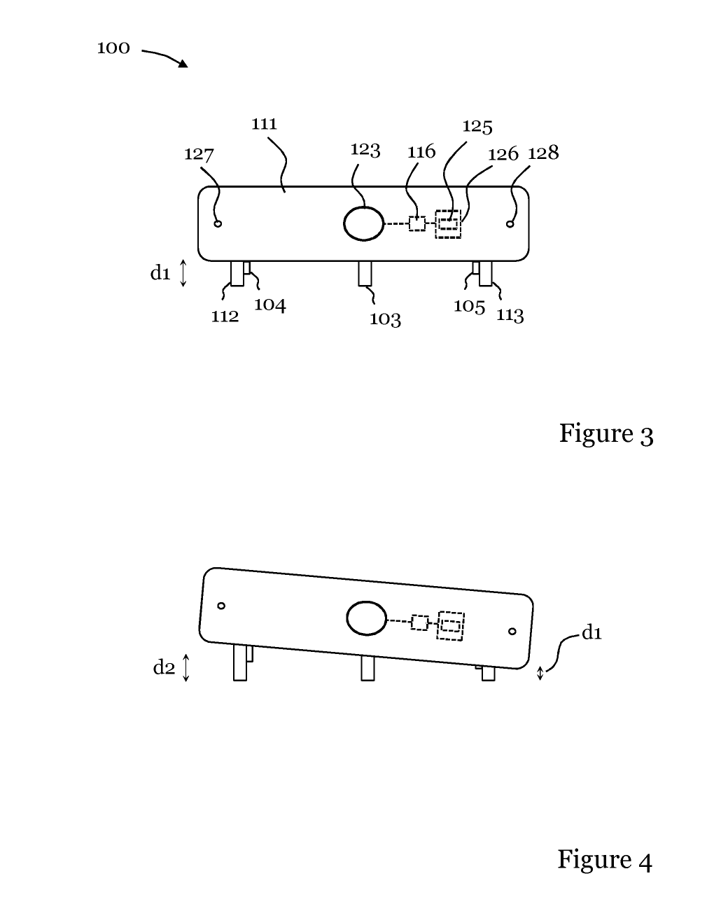

FIG. 3 shows a front view of the robotic vacuum cleaner 100 discussed with reference to FIGS. 2a and 2b in an embodiment.

A number of different obstacle detection systems can be envisaged. However, shown is a 3D sensor system comprising a camera 123 and a first and a second line laser 127, 128, which may be horizontally or vertically oriented line lasers. Further shown are the controller 116, the main body 111, the driving wheels 112, 113, and the support wheel 103. The controller 116 is operatively coupled to the camera 123 for recording images of a vicinity of the robotic cleaning device 100. The first and second line lasers 127, 128 may preferably be vertical line lasers and are arranged lateral of the camera 123 and configured to illuminate a height and a width that is greater than the height and width of the robotic cleaning device 100. Further, the angle of the field of view of the camera 123 is preferably smaller than the space illuminated by the first and second line lasers 127, 128. The camera 123 is controlled by the controller 116 to capture and record a plurality of images per second. Data from the images is extracted by the controller 116 and the data is typically saved in memory 126 along with a computer program 125 executed by the controller 116 for attaining a desired functionality.

Now, upon detecting an obstacle by controlling the camera 123 to capture images of the vicinity of the robotic device 100 and analysing the captured images, the controller 116 receives an indication of a need to adjust the height of the robot 100, as e.g. was discussed with reference to FIGS. 1a and 1b.

The controller 116 will thus control actuators 104, 105 arranged at the first driving wheel 112 and the second driving wheel 113, respectively, to accomplish the desired height d1 of the bottom side of the main body 111 over the floor, either by pressing the drive wheels 112, 113 against the floor thereby causing the main body 111 to elevate to a greater height, or by releasing the pressure thereby causing the main body to fall to a lower height. The actuators may be embodied in the form of pistons employing e.g. electromechanical, pneumatic, hydraulic or electrical operation.

This arrangement will further facilitate sufficient traction between the driving wheels and the surface in order to prevent the wheels from slipping when passing over obstacle like cables and thresholds, or when moving over a slippery surface, e.g. a linoleum floor. This is particularly important since the robotic cleaning device 100 typically uses dead reckoning to determine position and heading, thereby into account the turns of the driving wheels.

FIG. 4 further illustrates that not only can the height of the robotic cleaning device 100 over the surface be decreased or increased; the robotic cleaning device 100 may further be tiled in any direction. As shown in FIG. 4, the controller 116 may control the actuators 104, 105 to adjust the height of the robotic device 100 such that a first height d1 is attained at the first driving wheel 112, while a second height d2 is attained at the second driving wheel 113.

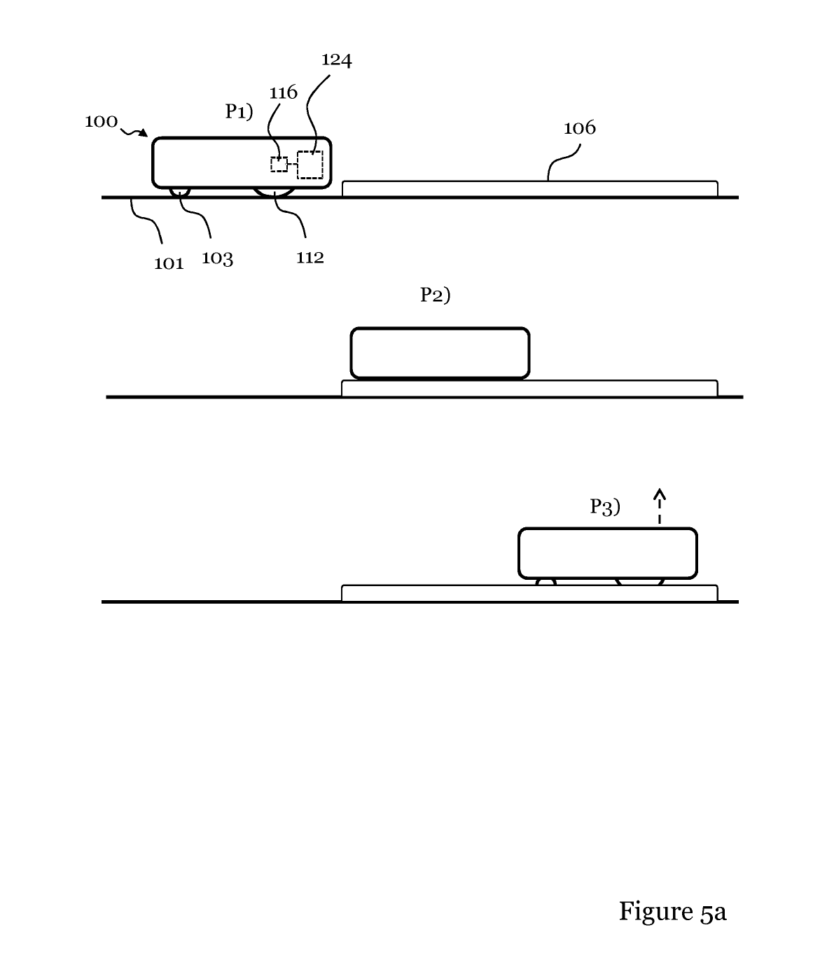

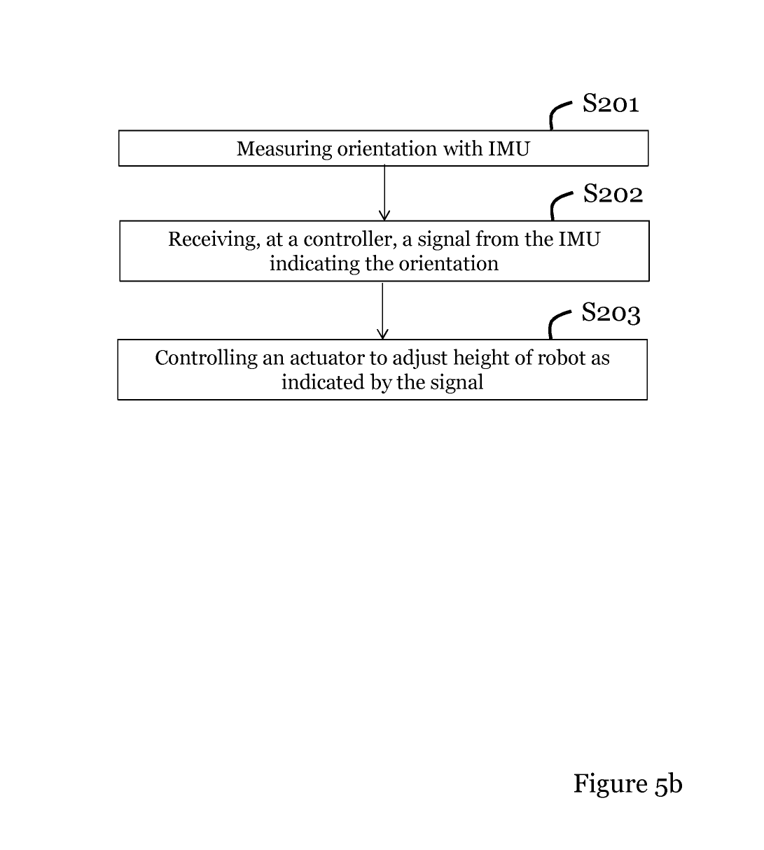

FIG. 5a illustrates a further embodiment of the method of adjusting the height of the robotic device 100 over the surface to be cleaned. However, in this embodiment, a less complex autonomous robotic vacuum cleaner 100 is utilized, lacking a 3D sensor system, but being equipped with an inertia measurement unit (IMU) 124, as previously described with reference to FIG. 1. Hence, the IMU 124 may be used as a surface detection device for detecting a type, or structure, of the surface 101 over which the robotic device 100 moves.

Reference is further made to a flowchart of FIG. 5b illustrating the method of adjusting the height of the robot in accordance with this particular embodiment.

In FIG. 5a, the robotic vacuum cleaner 100 moves over a floor 101 to be cleaned in a first position P1 and approaches a thick rug 106.

When traversing the thick rug 106 at a second position P2, the robotic vacuum cleaner 100 will have a different pattern of movement as compared to when moving over the smooth surface 101 and will typically tilt from side to side. As is illustrated at the second position P2, the robotic vacuum cleaner 100 sinks into the thick rug 106, and may have problems moving over the rug 106, or even get stuck.

Hence, at the second position P2, the IMU 124 measures in step S201 orientation of the robotic vacuum cleaner 100, such as the characteristically tilting back and forth indicating that a thick rug 106 is traversed, and signals the controller 116 of the need to adjust the height of the robotic vacuum cleaner 100 in step S202.

At a third position P3, the controller 116 controls the actuator configured to adjust the height of the robotic cleaning device in step S203 in accordance with the indicated need as signalled by the IMU 124 measuring orientation.

Thus, at position P3, the height of the robotic vacuum cleaner 100 over the floor lot has been increased, thereby advantageously avoiding—or at least mitigating—the risk of having the robotic vacuum cleaner get stuck on the rug 106, again by the actuator pressing the drive wheel 112 (and possibly the support wheel 103) towards the floor lot, thereby causing the main body 111 to be elevated to distance d2.

After having traversed the rug 106, the height of the robotic vacuum cleaner 100 may again be decreased by the controller releasing the pressure applied by the actuators onto the driving wheels.

It should be noted that a combination of a 3D sensor system and an IMU can be envisaged, where the height may be adjusted in response to detection of an object and/or a particular surface type (in this embodiment detected by measuring the orientation of the robot 100.

Further, by using an IMU 124, an uneven surface may advantageously be compensated for. Referring to FIG. 3, an uneven surface may be detected by measuring orientation of the robotic cleaning device 100, and it is according to an embodiment possible to individually control the respective piston device 104, 105 to adjust the position of the drive wheel 112, 113 at which it is arranged, such that the robotic cleaning device 100 may be tilted as required by the uneven surface.

FIG. 6a illustrates a further embodiment of the method of adjusting the height of the robotic device 100 over the surface to be cleaned. However, in this embodiment, the height is adjusted as a reaction of a measure of suction power of a suction fan 120 creating an air flow for transporting debris to a dust bag or cyclone arrangement (not shown) housed in the main body via an opening 118 in the bottom side of the main body 111.

The suction fan 120 is driven by a fan motor 121 communicatively connected to the controller 116 from which the fan motor 121 receives instructions for controlling the suction fan 120. The suction power of the suction fan 120 is thus typically measured indirectly by measuring operational current of the fan motor 121.

Hence, the fan motor 121 may be used as a surface detection device for detecting a type, or structure, of the surface 101 over which the robotic device 100 moves.

Reference is further made to a flowchart of FIG. 6b illustrating the method of adjusting the height of the robot in accordance with this particular embodiment.

In FIG. 6a, the robotic vacuum cleaner 100 again moves over a floor 101 to be cleaned in a first position P1 and approaches a thick rug 106.

When moving over the smooth floor 101, the height of the robotic vacuum cleaner 100 is typically adjusted so that the bottom side of the main body 111 is very close to the floor lot. The suction power of the fan 120 is then typically at an adequate level.

When traversing the thick rug 106 at a second position P2, the robotic vacuum cleaner 100, the opening 118 may be filled with fibres of the rug 106 (potentially even plugging the opening 118) causing the motor 121 to rev and the suction power of the suction fan 120 to increase.

In order to avoid a breakdown of the motor 121 and/or fan 120, or at least to decrease the suction power of the fan 120, the height of the robotic cleaning device 100 is advantageously adjusted.

Hence, at the second position P2, the controller 116 determines from a measured increase in suction power of the suction fan 120 in step S301 that the height should be increased (possibly in an indirect manner by measuring operational current of the fan motor 121).

Hence, the measured increase in suction power is signalled in step s302 to the controller 116 indicating the need to adjust the height of the robotic vacuum cleaner 100. For instance, the measure suction power or fan motor operational current is compared to a threshold value indicating a need to elevate the main body 111 of the robotic vacuum cleaner 100 to a particular height.

At a third position P3, the controller 116 controls the actuator configured to adjust the height of the robotic cleaning device in step S303 in accordance with the indicated need as signalled by the suction fan 120.

Thus, at position P3, the height of the robotic vacuum cleaner 100 over the floor 101 has been increased, thereby advantageously avoiding the risk of having the fibres of the rug plug the opening 118 and in worst cause a breakdown of the motor 121 and/or the fan 120.

It should be noted that a combination of a 3D sensor system and an IMU can be envisaged, where the height may be adjusted in response to detection of an object and/or orientation.

Further, the main body 111 may optionally be arranged with a cleaning member 117 for removing debris and dust from the surface to be cleaned in the form of a rotatable brush roll arranged in an opening 118 at the bottom of the robotic cleaner 100, as was discussed with reference to FIG. 1. In order to rotate the brush roll 117, a brush roll motor 119 is operatively coupled to the brush roll to control its rotation in line with instructions received from the controller 116.

Alternatively, instead of measuring suction power of a suction fan 120, it would be possible to measure operational current of the brush roll motor 119; traversing a thick rug 106 at a low height would cause the operational current of the brush roll motor 119 to increase, indicating that the height of the robotic vacuum cleaner should be increased.

Hence, the brush roll motor 119 and the brush roll 117 may be used as a surface detection device for detecting a type, or structure, of the surface 101 over which the robotic device 100 moves.

As can be deducted from the description of the above embodiments, the method of adjusting the height of the robotic cleaning device 100 over the surface lot across which it moves may advantageously be performed for different reasons; firstly, it may be performed to avoid colliding with objects, and secondly it may be performed to facilitate movement over objects/surfaces not easily traversed, such as thick rugs. Further, it may be performed to optimize cleaning capacity of the robotic cleaning device 100, where the height could be adjusted to be higher in case of a smooth easy-cleaned surface such as a parquet of linoleum floor, while it would be adjusted to be lower in case of a structured surface such as a fitted carpet where the debris is not as easily removed.

In yet an alternative embodiment, the driving wheel motors 115a, 115b may be used as a surface detection device for detecting a type, or structure, of the surface lot over which the robotic device 100 moves.

Traversing a thick rug 106 would cause the operational current of the driving wheel motors 115a, 115b to increase, indicating that the height of the robotic vacuum cleaner may need to be increased.

Hence, by measuring operational current of the driving wheel motors, an indication is given of a potential need to adjust height of the robotic cleaning device over the surface.

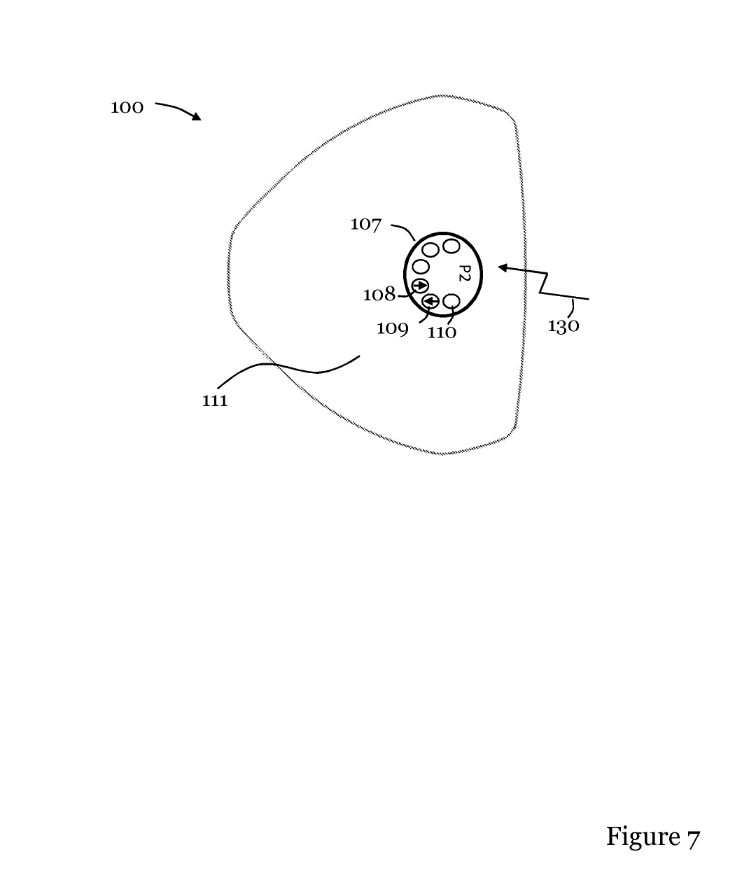

FIG. 7 shows a top view of a robotic cleaning device 100 according to a further embodiment. On the main body 111 of the robotic cleaning device 100, a user interface 107 communicatively coupled to the controller 116 is arranged comprising a number of touch buttons 108, 109, 110 via which a user can instruct the cleaning device to e.g. perform a desired cleaning program. Further, the user interface may comprise display means for visually indicating a selected cleaning program (in this example “P2”) to the user.

In an embodiment, a user can manually operate the touch buttons of the user interface 107 to adjust the height of the robotic cleaning device 100 as previously described. For instance, user operation of a first button 108 may cause the robotic cleaning device 100 to be raised from the floor, while user operation of a second button 109 may cause the robotic cleaning device 100 to be lowered against the floor.

In a further embodiment, the user need not provide input to the user interface 107 by physically touching the buttons or keys 108, 109, but may alternatively communicate wirelessly 130 with the user interface via a remote control. It may further be envisaged that a central robot control system sends wireless operating signals to the user interface 107 of the robotic cleaning device 100 via for instance Wireless Local Area Network (WLAN), commonly referred to as WiFi.

The invention has mainly been described above with reference to a few embodiments. However, as is readily appreciated by a person skilled in the art, other embodiments than the ones disclosed above are equally possible within the scope of the invention, as defined by the appended patent claims.

1. A method of adjusting a height of a robotic cleaning device over a surface across which the robotic cleaning device moves, the method comprising:
receiving a signal indicative of a need to adjust the height of the robotic cleaning device over the surface; and
controlling, in response to the received signal, at least one actuator configured to adjust the height of the robotic cleaning device in accordance with the indicated need.

2. The method of claim 1, wherein controlling the at least one actuator comprises:
controlling the at least one actuator to adjust a position of at least one drive wheel of the robotic cleaning device with respect to a main body of the robotic cleaning device to attain the height adjustment.

3. The method of claim 2, wherein the at least one actuator comprises a piston device arranged at each driving wheel configured to individually adjust the position of each driving wheel with respect to the main body of the robotic cleaning device.

4. The method of claim 1, further comprising:
detecting an object encountered by the robotic cleaning device using an object detection device, a signal received from the object detection device in response to detecting the object being indicative of the need to adjust height of the robotic cleaning device over the surface.

5. The method of claim 1, further comprising:
detecting a type of surface across which the robotic cleaning device moves using a surface detection device, a signal received from the surface detection device in response to detecting the type of surface being indicative of the need to adjust height of the robotic cleaning device over the surface.

6. The method of claim 5, wherein detecting the type of surface comprises:
measuring an orientation of the robotic cleaning device using an inertia measurement unit (“IMU”), a signal received from the IMU in response to measuring the orientation being indicative of the need to adjust height of the robotic cleaning device over the surface.

7. The method of claim 5, wherein detecting the type of surface comprises:
measuring a suction power of a suction fan configured to create an air flow for transporting debris from the surface over which the robotic cleaning device moves to a container in the main body via an opening in the bottom side of the main body, a signal received from the suction fan in response to measuring the suction power being indicative of the need to adjust height of the robotic cleaning device over the surface.

8. The method of claim 5, wherein detecting the type of surface comprises:
measuring an operational current of a brush roll motor arranged to rotate a brush roll for removing debris from the surface over which the robotic cleaning device moves, a signal received from the brush roll motor in response to measuring the operational current being indicative of the need to adjust height of the robotic cleaning device over the surface.

9. The method of claim 5, wherein detecting the type of surface comprises:
measuring an operational current of at least one wheel motor for enabling movement of at least one driving wheel causing the robotic cleaning device to move across the surface, a signal received from the at least one wheel motor in response to measuring the operational current being indicative of the need to adjust height of the robotic cleaning device over the surface.

10. The method of claim 1, further comprising:
receiving a control signal via a user interface of the robotic cleaning device being physically operated by a user, the received control signal being indicative of the need to adjust height of the robotic cleaning device over the surface.

11. The method of claim 1, further comprising:
receiving a wireless control signal via a user interface of the robotic cleaning device, the received wireless control signal being indicative of the need to adjust height of the robotic cleaning device over the surface.

12. A robotic cleaning device comprising:
at least one actuator configured to adjust a height of the robotic cleaning device over a surface across which the robotic cleaning device moves; and
a controller configured to:
receive a signal indicative of a need to adjust height of the robotic cleaning device over the surface; and further to
control, in response to the received signal, said at least one actuator configured to adjust height of the robotic cleaning device in accordance with the indicated need.

13. The robotic cleaning device of claim 12, further comprising:
a main body; and
at least one drive wheel configured to move the robotic cleaning device over the surface;
the controller being configured to:
control the at least one actuator to adjust a position of at least one drive wheel of the robotic cleaning device with respect to the main body of the robotic cleaning device to attain the height adjustment.

14. The robotic cleaning device of claim 13, wherein the at least one actuator comprises a piston device arranged at each driving wheel configured to individually adjust the position of each driving wheel with respect to the main body of the robotic cleaning device.

15. The robotic cleaning device of claim 12, further comprising:
an object detection device configured to detect an object encountered by the robotic cleaning device;
the controller being configured to:
receive a signal from the object detection device in response to detecting the object being indicative of the need to adjust height of the robotic cleaning device over the surface.

16. The robotic cleaning device of claim 12, further comprising:
a surface detection device configured to detect a type of surface across which the robotic cleaning device moves;
the controller being configured to:
receive a signal from the surface detection device in response to detecting the type of surface being indicative of the need to adjust height of the robotic cleaning device over the surface.

17. The robotic cleaning device of claim 16, the surface detection device comprising:
an inertia measurement unit (“IMU”) configured to measure an orientation of the robotic cleaning device;
the controller being configured to:
receive a signal from the IMU in response to measuring the orientation being indicative of the need to adjust height of the robotic cleaning device over the surface.

18. The robotic cleaning device of claim 16, the surface detection device comprising:
a suction fan configured to create an air flow for transporting debris from the surface across which the robotic cleaning device moves to a container in the main body via an opening in the bottom side of the main body; and
a fan motor configured to drive the suction fan;
the controller being configured to:
receive a signal from the fan motor indicating measured an operational current of the fan motor, the signal being indicative of the need to adjust height of the robotic cleaning device over the surface.

19. The robotic cleaning device of claim 16, the surface detection device comprising:
a brush roll configured to remove debris from the surface across which the robotic cleaning device moves; and
a brush roll motor configured to rotate the brush roll;
the controller being configured to:
receive a signal from the brush roll motor indicating a measured operational current of the brush roll motor, the signal being indicative of the need to adjust height of the robotic cleaning device over the surface.

20. The robotic cleaning device of claim 16, the surface detection device comprising:
at least one driving wheel configured to cause the robotic cleaning device to move across the surface; and
at least one wheel motor configured to rotate the at least one driving wheel;
the controller being configured to:
receive a signal from the at least one wheel motor indicating a measured operational current of the at least one wheel motor, the signal being indicative of the need to adjust height of the robotic cleaning device over the surface.

21. The robotic cleaning device of claim 16, the robotic cleaning device further comprising:
a user interface configured to receive a control signal from a user physically operating the interface, the received control signal being indicative of the need to adjust height of the robotic cleaning device over the surface.

22. The robotic cleaning device of claim 16, the robotic cleaning device further comprising:
a user interface configured to receive a wireless control signal, the received wireless control signal being indicative of the need to adjust height of the robotic cleaning device over the surface.

23-24. (canceled)
